(19) United States
(12) Patent Application Publication
(10) Pub. No.: US 2016/0003367 A1
(43) Pub. Date: Jan. 7, 2016

(54) SPRINGLESS REGULATOR

(71) Applicant: HCT Group Holdings Limited, Santa Monica, CA (US)

(72) Inventor: Michael B. Jones, Excelsior, MN (US)

(21) Appl. No.: 14/321,536

(22) Filed: Jul. 1, 2014

(51) Int. Cl. F16K 17/12; F16K 3/30; F16K 31/12; F16K 17/164

(52) U.S. Cl. CPC F16K 17/12; F16K 17/164; F16K 3/30; F16K 31/12

(57) ABSTRACT

A regulator includes a housing having an inlet, an outlet, and a chamber. The regulator also includes a barrier assembly disposed within the housing, and the barrier assembly includes a first portion moveable relative to the chamber, and a second potion configured to selectively fluidly connect the inlet to the chamber. The regulator further includes a head removably connected to the chamber. The head forms at least part of a first gap extending from the head to a first side of the first portion of the barrier assembly. In such an embodiment, the first gap is characterized by a first fluid pressure biasing the barrier assembly in a first direction away from the head. Additionally, the first portion includes a second side opposite the first side, and the second side forms at least part of a second gap extending from the second side to a base of the chamber. The second gap is characterized by a second fluid pressure, and the first portion is moveable in response to a change in the second fluid pressure.

### BACKGROUND

Devices exist for dispensing fluids (i.e., liquids and/or gases) such as paint, water, pesticides, cosmetics, medicinal products, and other products. Such devices usually consist of an outer tubular shell, a delivery mechanism for displacement of the product, and a nozzle for dispersing the product in a controlled manner. For example, in the medical industry, dispensers are employed for applying medicinal products, such as antiseptics, to portions of the body. In the cosmetics and personal care industries, dispensers are used to apply moisturizers, lotions, sunscreen, perfumes and other cosmetic products to portions of the body. Additionally, in the home improvement industry, dispensers are used to spray water, paint, pesticides, and other such products onto hard surfaces such as fences, decks, landscaping, and the like. Such dispensers may also be used in the sports and entertainment industry, such as with paint ball guns and other like gas-powered guns.

Conventional dispensers typically require manual pumping or propellants to dispense the example products described above during use, and such dispensers also include one or more regulators configured to regulate a pressure imparted to the product. For example, such regulators may ensure that a consistent pressure is imparted to the product regardless of the pressure provided by manual pumping or propellants. Known regulators include a moveable component disposed within an internal chamber to selectively permit passage of, for example, compressed carbon dioxide or other like fluids into the chamber. Such components are biased within the chamber by a conventional spring. However, such springs can be costly to procure and are typically the most expensive component of such regulators.

### SUMMARY

This summary is provided to introduce simplified concepts of regulators configured for use with fluid dispensers, and example regulators are further described below in the Detailed Description. This summary is not intended to identify essential features of the claimed subject matter, nor is it intended for use in determining the scope of the claimed subject matter.

This disclosure is directed to regulators having a housing, and a barrier assembly moveably disposed within the housing, wherein the barrier assembly is biased by a compressed fluid. For example, the barrier assembly may be biased in a first direction away from a head disposed at a fixed location within the housing. In such embodiments, the barrier assembly and the head may be disposed within a chamber of the housing, and each may be substantially fluidly sealed to an inner wall of the chamber. When various components of the present disclosure are “substantially fluidly sealed” in this way, substantially no fluid may pass between such components, even under positive fluid pressures up to at least 100 psi or under negative fluid pressures up to at least negative 100 psi. A first gap may be formed within the chamber between the head and the barrier assembly, and fluid, such as air, may be compressed between the head and the barrier assembly within the first gap. For example, air and/or other fluids within the first gap may have a first fluid pressure, and this first fluid pressure may act to bias the barrier assembly in a direction away from the head. In some embodiments, the position of the head within the chamber may be adjustable, and movement of the head relative to the piston may result in a commensurate change (i.e., an increase or decrease) in the first fluid pressure within the first gap.

The inner wall of the chamber may extend substantially from a base of the chamber, and a second gap may be formed between the base of the chamber and the barrier assembly. In particular, the barrier assembly may include a first portion and a second portion extending substantially perpendicularly from the first portion. The first portion may include a first side facing the head and a second side, opposite the first side, facing the base of the chamber. In such embodiments, the first side may define and/or otherwise form at least part of the first gap and the second side may define and/or otherwise form at least part of the second gap. In such embodiments, the second gap may include a fluid having a second fluid pressure.

When the first fluid pressure is substantially equal to the second fluid pressure, the barrier assembly may remain stationary within the chamber. Additionally, when the first fluid pressure is substantially equal to the second fluid pressure, the second portion of the barrier assembly may be substantially fluidly sealed to the housing such that the second portion may block fluid from entering the second gap via an inlet of the housing. However, when the second fluid pressure dips below the first fluid pressure, such as when fluid is released through an outlet of the regulator during dispensing of the product from the dispenser, the biasing force applied by the first fluid pressure may cause the barrier assembly to move away from the head toward the base of the chamber. Movement of the barrier assembly in this way may cause commensurate movement of the second portion of the barrier assembly. Such movement of the second portion may, for example, permit pressurized fluid to enter the second gap via at least part of the second portion. Such pressurized fluid may be supplied by, for example, a pressure vessel fluidly coupled to the inlet of the housing. Pressurized fluid entering the second gap may, for example, increase the fluid pressure within the second gap. In one embodiment, fluid may enter the second gap until the second fluid pressure substantially equals the first fluid pressure and/or until the second portion again forms a substantially fluid-tight seal with the housing.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 shows a perspective view of an illustrative dispenser having a pressure vessel communicatively coupled with a chamber.

FIG. 2 shows a cross-sectional view of the dispenser shown in FIG. 1.

FIG. 3 shows an example regulator employed by the dispenser.

FIG. 4 shows another example regulator employed by the dispenser.

FIG. 5 shows a flowchart illustrating an example method of the present disclosure.

### DETAILED DESCRIPTION

This disclosure is directed to regulators configured for use with any of a variety of fluid dispensers or other apparatuses. In some embodiments, example dispensers may include pressure vessels communicatively coupled with one or more chambers housing a fluid product to be dispensed. The pressure vessels apply a compressed gas to the chambers housing the product to displace the product from the chamber and expel the product out of a nozzle.

In some embodiments, the regulator may be disposed in a fluid path between the pressure vessel and the one or more chambers, and the regulator may ensure that a consistent desired pressure is applied to the product when the product is displaced from the chamber. For instance, the regulator may include a housing having an internal chamber, a head substantially fluidly-sealed to an inner wall of the chamber, and a barrier assembly moveably disposed within the chamber relative to the head. In one embodiment, a first gap may be formed between the head and a first portion of the barrier assembly, and the first gap may be characterized by a positive first fluid pressure. In such embodiments, the first fluid pressure may bias the barrier assembly in a direction away from the head.

The chamber of the housing may also include a base, and a second gap may be formed between the base and the first portion of the barrier assembly. In such embodiments, the second gap may be characterized by a positive second fluid pressure. When the first and second fluid pressures are substantially equal, the barrier assembly may remain stationary relative to the head such that substantially no fluid may enter or exit the regulator. When the second fluid pressure dips below the first fluid pressure, on the other hand, the bias force applied by the first fluid pressure may cause the first portion of the barrier assembly to move in the first direction. Such movement may allow compressed gas from the pressure vessel to enter the second gap, thereby increasing fluid pressure within the second gap. The increase in pressure may result in movement of the first portion of the barrier assembly in a second direction, opposite the first direction, until the second fluid pressure is substantially equal to the first fluid pressure and equilibrium within the regulator is reached.

By virtue of the regulator controlling the pressure at which compressed gas from the pressure vessel may be directed to the chamber housing the product to be dispensed, regulators of the present disclosure may enable the product to be properly sprayed at the appropriate pressure to atomize the product. Further, because various example regulators of the present disclosure do not employ a spring to bias the internal barrier assembly, the regulators described herein are less expensive and less complicated than conventional regulators, and are also less prone to failure due to component fatigue. It is understood, however that other example regulators of the present disclosure may include one or more conventional springs used for other purposes or functions.

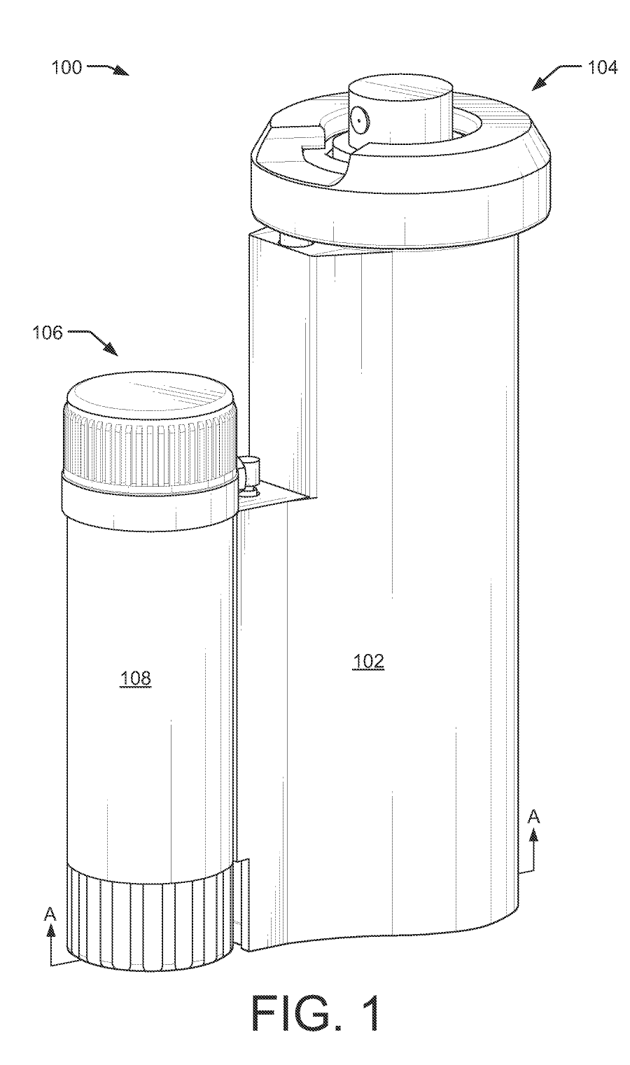

FIG. 1 represents an illustrative dispenser 100 having a housing 102 for holding a pressure vessel and a reservoir. While FIG. 1 illustrates the housing 102 having a first portion 104 to house a reservoir adjacent to a second portion 106 to house the pressure vessel, the first and second portions 104 and 106 may be integrated. In an example embodiment, the second portion 106 may comprise a holder 108 configured to support and/or otherwise house the pressure vessel while the pressure vessel is fluidly connected to one or more components of the dispenser 100, such as to a regulator thereof. In some embodiments, the pressure vessel may be, for example, disposed substantially within the holder 108 while the pressure vessel is fluidly connected to an inlet of the regulator. For ease of description, the embodiments of the present disclosure will be described with respect to the example dispenser 100, housing 102, and other configurations illustrated in FIG. 1. However, the example regulators and other components of the present disclosure may be employed with any of a variety of different known dispensers for dispensing fluid products such as paint, water, pesticides, cosmetics, medicinal products, and other liquids or gases. Thus, the dispenser 100 illustrated in FIG. 1 and described herein is merely exemplary, and is in no way intended to limit the scope of the present disclosure.

As shown in FIG. 1, an example housing 102 may comprise a single portion arranged to house both a pressure vessel and a reservoir. For example, the housing 102 may comprise one single unit ergonomically shaped to be comfortably gripped by a hand of a user, and house both a pressure vessel and a reservoir. In one example, the housing 102 may comprise a single unit having a convex crescent shaped body arranged to be grasped and manipulated by a hand of a user. The convex crescent shaped unit may have a reservoir (e.g., a collapsible product reservoir) arranged adjacent to a pressure vessel (e.g., a carbon dioxide (CO2) cartridge). In another example, the first portion 104 of the housing 102 and the second portion 106 of the housing 102 may be arranged end-to-end (e.g., coaxially). For example, the housing 102 may comprise a substantially cylindrical shape and the reservoir and the pressure vessel may be disposed end-to-end.

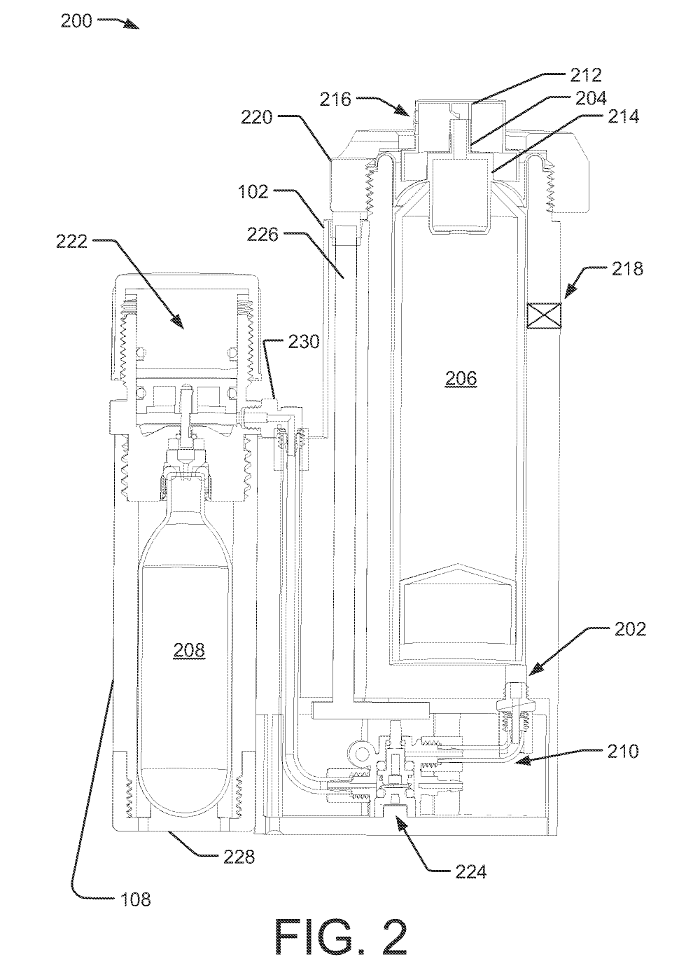

FIG. 2 shows a section view 200 of the dispenser 100 taken along line A-A illustrated in FIG. 1. FIG. 2 illustrates the housing 102 may have a pressurized gas inlet 202 and a product outlet 204. The housing 102 may include a chamber 206 for containing or storing a product (e.g., a gas, a liquid, a gel). In some examples, the chamber 206 may contain at least about 15 ml of product to at most about 100 ml of product. In other examples, the volume of the chamber 206 may be larger or smaller than the foregoing range.

The chamber 206 may be coupled to the product outlet 204 and the pressurized gas inlet 202. The pressurized gas inlet 202 may comprise an aperture arranged in a portion of the chamber 206 and communicatively coupled to a pressure vessel 208. For example, one or more fluid fittings, tubes, ports, channels etc. may interconnect the pressurized gas inlet 202 to the pressure vessel 208. The one or more fluid fittings, tubes, ports, channels etc. interconnecting the pressurized gas inlet to the pressure vessel 208 define a pressure path 210. In one example, the pressure path 210 may simply be a channel formed integral with the housing 102. The chamber 206 may be under pressure (e.g., pressurized) during use and the dispenser 100 may commence spraying product upon actuation by a user. Because the chamber 206 may be under constant pressure, this eliminates pressure ramp up delay and poor atomization (e.g., spitting) associated with pressure ramp up.

The pressure vessel 208 may comprise a carbon dioxide (CO2) cartridge. For example, the pressure vessel 208 may comprise at least about a 4 gram disposable CO2 cartridge to at most about a 32 gram disposable CO2 cartridge. The CO2 cartridge may be pressurized up to about 860 pounds per square inch (psi) of pressure at room temperature. In one example, one 16 gram CO2 cartridge may last for at least about 60 product refills of a chamber having a volume of about 24 ml. In another example, one 8 gram CO2 cartridge may last for at least about 34 product refills of the chamber having a volume of about 24 ml. In other examples, the pressure vessel may be any sized CO2 vessel. In other examples, the pressure vessels 208 may comprise other compressed gasses, or liquid/gas mixture. For example, the pressure vessel 208 may comprise nitrogen, butane, argon, nitrous oxide, propane, or a mixed gas. The compressed gas contained in the pressure vessel 208 may impart a pressure to the chamber 206 containing the product. Here, the compressed gas may be mixed with the product contained in the chamber 206. In other embodiments, on the other hand, the compressed gas may be isolated from (i.e., not mixed) with the product.

A nozzle 212 may be coupled to the product outlet 204 of the housing 102 to dispense the product. A valve 214 may be coupled with the chamber 206 containing the product and actuatable to allow the product to be expelled from the chamber 206 containing the product through the nozzle 212. The nozzle 212 may be movably coupled to the actuatable valve 214. For example, a user may displace the nozzle 212 to actuate the valve 214 to allow the product to be expelled from the chamber 206. For example, when a user selectively actuates the valve 214, the pressure imparted to the chamber 206 containing the product expels the product contained in the chamber 206 through the nozzle 212.

The nozzle 212 may have an orifice 216 arranged to atomize the expelled product. For example, the nozzle 212 may comprise an orifice 216 having a geometry tailored to one or more properties of the product housed in the chamber 206. In one example, the orifice 216 may have an inside diameter based on a viscosity of a fluid contained in the chamber 206. Moreover, while FIG. 2 shows the nozzle 212 comprising a depressible button, the nozzle 212 may comprise any shape. For example, the nozzle 212 may comprise an elongated tab shape arranged to be displaced transversely relative to the housing 102. In one example, the elongated tab shape may be substantially convex crescent shaped and arranged to be displaced transversely relative to the housing 102 via a thumb of a hand of a user. The nozzle 212 may comprise any shape suitable for actuating the valve 214 to expel the product and for dispensing the product. The size, shape, and dispensing pattern may vary depending on the product to be dispensed. For instance, a nozzle having a small dispensing orifice may be used for dispensing a low viscosity liquid (e.g., perfume) while a larger orifice may be used for dispensing a more viscous liquid, or gel.

The section view 200 of FIG. 2 illustrates a port 218 arranged in a portion of the chamber 206. The port 218 may provide for filling the chamber 206 with a product. For example, the port 218 may be arranged to be communicatively coupled to a syringe or other refill mechanism to receive a product. In one example, a user may choose a syringe from a plurality of syringes to fill the chamber 206 with a product. For example, a user may choose a syringe having a desired colored product to fill the chamber 206 with. In another example, the port 218 may be arranged to be communicatively coupled to a fitting (e.g., a coupler, a quick disconnect, a nipple, etc.). In another example, the dispenser 100 may include a top 220 removably coupled to the housing 102 to enclose the chamber 206. In this example, a user may remove the top 220 from the housing 102 to fill the chamber 206. While the section view 200 illustrates the top 220 having mechanical threads for removably coupling the top 220 to the housing 102, the top 220 may be coupled to the housing 102 via other mechanisms. For example, the top 220 may snap-fit, press-fit, twist-lock fit or the like to the housing 102. Further, the top 220 and the nozzle 212 may be formed as a single unit. For example, the top 220 may include the orifice 216 communicatively coupled with the product outlet 204. In this example, where the top 220 and the nozzle 212 are formed as a single unit, the top 220 may be arranged to be displaced to actuate the valve 214 to allow the product to be expelled. For example, the top 220 may be arranged to be displaced transversely relative to the housing 102 to actuate the valve 214 to allow the product to be expelled.

In other examples, the top 220 may be irremovably coupled or fixed to the housing 102. In this example, where the top 220 is irremovable from the housing 102, the dispenser 100 may not be reusable. In an example where the dispenser 100 is not reusable and the top 220 is irremovably fixed to the housing 102, a user may deplete a product contained in the chamber 206 and simply dispose of the dispenser 100. However, in other examples, where the dispenser is reusable and the top 220 is irremovably fixed to the housing 102, a user may refill the chamber 206 via the port 218 and/or the product outlet 204. For example, the product outlet 204 may be arranged to be communicatively coupled with a syringe or other filling mechanism to fill the chamber 206 with a product. Further, the nozzle 212 may be removably coupled to the product outlet 204 and a user may remove the nozzle 212 to communicatively couple a syringe or other filling mechanism to the product outlet 204 to fill the chamber 206 with a product.

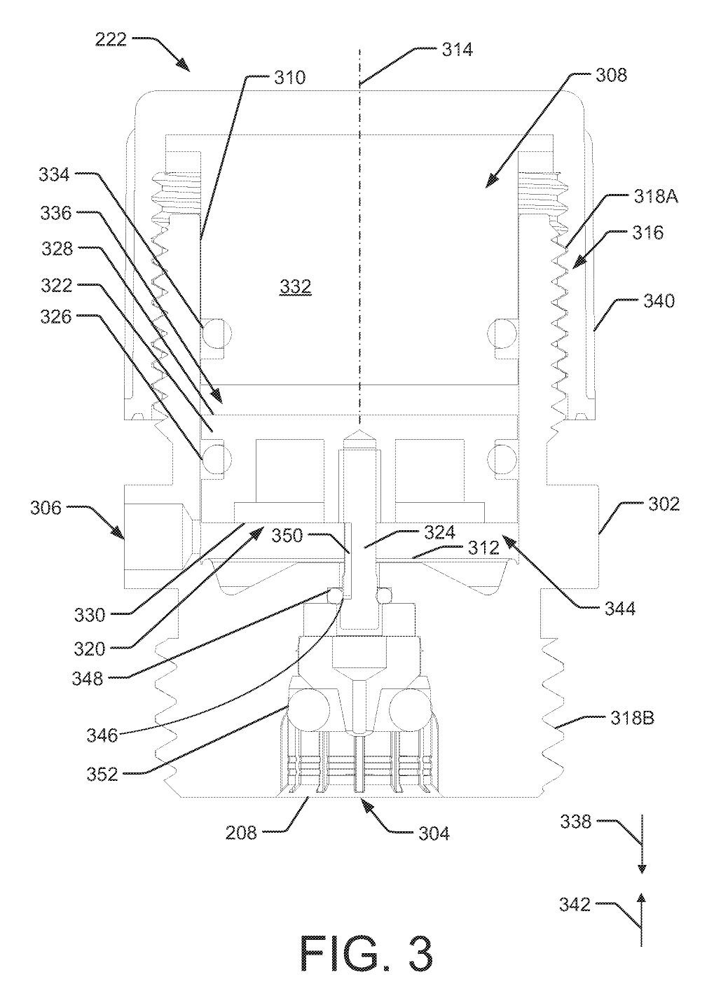

The section view 200 illustrates a regulator 222 arranged in the pressure path 210 between the chamber 206 containing the product and the pressure vessel 208 to regulate the pressure imparted to the chamber 206 containing the product. For example, the regulator 222 may reduce a pressure generated by the pressure vessel 208 to pressurize the chamber 206. In one example, the regulator 222 may reduce about 860 psi generated by a CO2 cartridge at room temperature to a pressure suitable for application of a product. Such a suitable pressure may be, for example, at least about 15 psi up to at most about 200 psi. In another example, such a suitable pressure may be at least about 50 psi up to at most about 100 psi. The regulator 222 may be a preset regulator or adjustable to adjust the pressure delivered to the chamber 206. The regulator 222 will be described in greater detail below with respect to FIG. 3.

A safety valve 224 may be arranged in the pressure path 210 between the regulator 222 and the chamber 206 containing the product. The safety valve 224 may be arranged in the pressure path 210 to selectively prevent a pressure from being imparted to the chamber 206 containing the product at certain times. For example, the safety valve 224 may be arranged in the pressure path 210 to provide for replacing or refilling the product contained in the chamber 206. In one example, a mechanism 226 may connect or link the safety valve 224 to the top 220 to provide for replacing or refilling the product contained in the chamber via the top 220. For example, when a user removes the top 220, the mechanism 226 may trigger the safety valve 224 to prevent the pressure from being imparted to the chamber 206. The mechanism 226 may comprise an electromechanical switch, hydraulic switch, magnetic switch, sensor switch, a member (e.g., a rod, a cable, a linkage, etc.) that triggers the safety valve 224. In another example, a mechanism may connect or link the safety valve 224 to the port 218 to provide for replacing or refilling the product contained in the chamber via the port 218. For example, when a user communicatively couples with the port 218 a mechanism may trigger the safety valve 224 to prevent the pressure from being imparted to the chamber 206.

The section view 200 illustrates the pressure vessel 208 being removably coupled with the pressurized gas inlet 202 of the chamber 206 to provide for replacing the pressure vessel 208. For example, and as section view 200 illustrates, a cap 228 may be removably coupled to the housing 102 and encase the pressure vessel 208 in a portion of the housing 102. The encased pressure vessel 208 may be communicatively coupled with the pressurized gas inlet 202 via the pressure path 210 arranged between the pressure vessel 208 and the chamber 206. In one example, a user may remove the cap 228 from the housing 102 to replace the pressure vessel 208. While the section view 200 illustrates the pressure vessel 208 being removably coupled with the pressurized gas inlet 202, the pressure vessel 208 may be irremovable or fixed with respect to the pressurized gas inlet 202. For example, the cap 228 may be irremovable or fixed to the housing 102 to prevent a user from accessing the pressure vessel 208. In this example, where the pressure vessel 208 is irremovably fixed in the housing 102, a user may dispose of the dispenser 100 after depleting the pressure vessel 208.

In some embodiments, one or more additional actuatable valves 230 may be arranged in the pressure path 210 between the regulator 222 and the chamber 206 containing the product. For example, the valve 230 may be fluidly connected to an outlet of the regulator 222, and may be configured to assist in directing and/or otherwise controlling the flow of pressurized fluid exiting the regulator 222. In some embodiments, the valve 222 may be substantially structurally similar to the valve 214 and/or the safety valve 224 described above. In further embodiments, the valve 230 may be omitted.

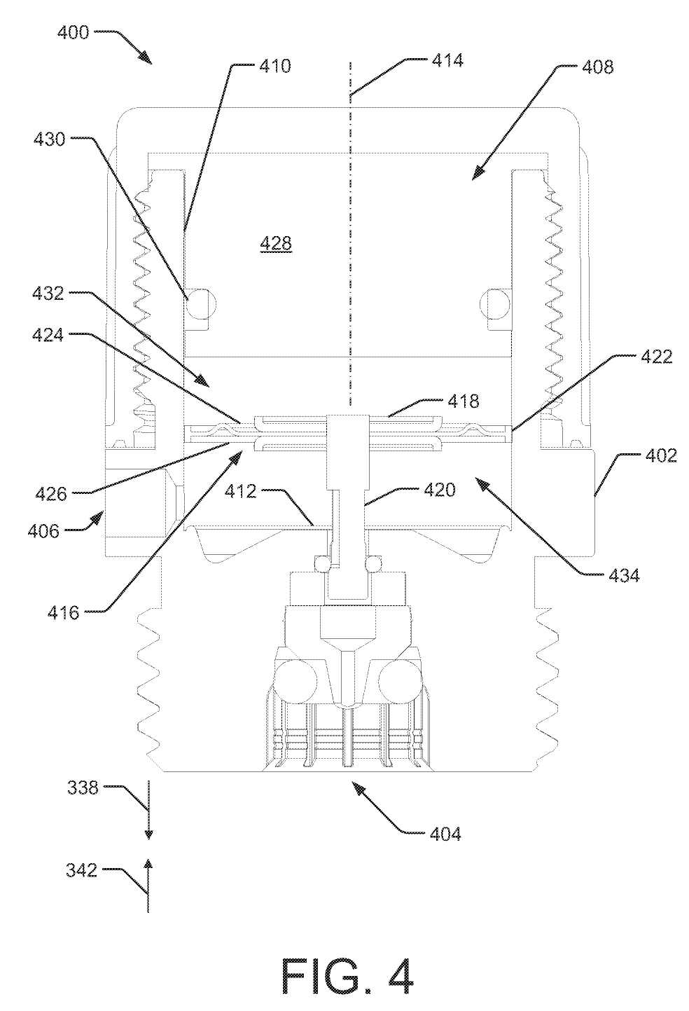

FIG. 3 shows a cross-sectional view of the regulator 222 illustrated in FIG. 2. While FIG. 2 illustrates the regulator 222 in use with the example dispenser 100, in further embodiments, the regulators described herein with respect to FIGS. 3 and 4 may be used with any other known dispenser or other like apparatus. As shown in FIG. 3, the regulator 222 includes a housing 302 having an inlet 304, an outlet 306, and a chamber 308. The chamber 308 may be, for example, a substantially cylindrical inner chamber of the housing 302, and may comprise one or more inner walls 310. In further embodiments, on the other hand, the chamber 308 may be substantially oval-shaped, substantially square-shaped, substantially rectangular-shaped, or any other like shape. In such embodiments, the chamber 308 may include a base 312 and a central longitudinal axis 314. In such embodiments, the inner wall 310 may extend substantially perpendicularly to the base 312, and the longitudinal axis 314 may extend substantially centrally through the chamber 308 such that the inner wall 310 is disposed circumferentially around the axis 314. Additionally, the housing 302 may be substantially hollow such that the base 312 may provide a fluid communication between, for example, the inlet 304 and the chamber 308. As will be described in greater detail below, one or more components of the regulator 222 may be disposed within the chamber 308 such that the inlet 304 may be selectively fluidly connectable to the chamber 308, such as, via the base 312.

In some examples, the housing 302 and/or other components of the regulator 222 may be formed from any metal, alloy, rubber, plastic, polymer, and/or other materials. For example, the housing 302 and/or one or more additional components of the regulator 222 may be made from stainless steel, aluminum, or other metals. In some embodiments, one or more such components may be made from polyethylene, polypropylene, or other polymers. Further, any known manufacturing process may be utilized to manufacture such components. For example, the housing 302 and/or other components of the regulator 222 may be forged, cast, milled, and/or otherwise machined in order to form the various features and other configurations illustrated in FIG. 3. Alternatively and/or in addition, such components may be manufactured via injection molding, blown film extrusion, and/or any other process. The materials used to manufacture the housing 302 and/or other components of the regulator 222 may be configured to withstand any of the pressures described herein.

The housing 302 may also include one or more outer walls 316. In such embodiments, one or more outer walls 316 of the housing 302 may comprise an outermost surface of the housing 302 while one or more inner walls 310 of the housing 308, such as the inner wall 310 forming the chamber 308, may comprise an inner most surface of the housing 302. In example embodiments, the outer wall 316 may include one or more features configured to assist in connecting the regulator 222 to other components of the dispenser 100 described above. For example, the outer wall 316 may include a first set of threads 318a configured to mate with corresponding threads of a cap removably connectable to the housing 302. Such an example cap will be described in greater detail below. Additionally, the outer wall 316 may include a second set of threads 318b configured to mate with corresponding threads of the holder 108. Such threads 318a, 318b may assist in facilitating a removable connection between the regulator 222 and other components of the dispenser 100. In further embodiments, in addition to or instead of one or more sets of threads 318a, 318b, a latch, flange, hook, snap connection, and/or other structure to assist in facilitating such a removable connection.

The regulator 222 may also include a barrier assembly 320 disposed within the housing 302. For example, the barrier assembly 320 may include a first portion 322 and a second portion 324, and at least one of the first and second portions 322, 324 of the barrier assembly 320 may be at least partially disposed within the chamber 308. Further, in some example embodiments at least the first portion 322 of the barrier assembly 320 may be movable relative to the chamber 308. In such embodiments, movement of the first portion 322 relative to the chamber 308 may result in corresponding movement of the second portion 324. For example, the second portion 324 of the barrier assembly 320 may be connected to and/or formed integral with the first portion 322 such that movement of the first portion 322 causes corresponding movement of the second portion 324. As shown in FIG. 3, the first and second portions 322, 324 may be substantially centrally disposed within the chamber 308 such that the first portion 322 and/or the second portion 324 may be movably disposed within the chamber 308 substantially along the longitudinal axis 314.

The first and second portions 322, 324 may be formed from any of the materials described above with respect to the housing 302. Likewise, the first and second portions 322, 324 may be formed using any of the manufacturing processes described above. In some embodiments, for example, the barrier assembly 320 may comprise a one-piece construction in which the first portion 322 is formed integral with the second portion 324. Alternatively, the barrier assembly 320 may comprise a two-piece construction in which the first portion 322 is connected to the second portion 324 through welding, soldering, threaded engagement, fusing, and/or other like techniques.

The first portion 322 and/or the second portion 324 may have any of a number of different shapes, sizes, orientations, and/or other configurations in order to enhance the functionality of the regulator 222. For example, although the first portion 322 is illustrated in FIG. 3 as having a substantially E-shaped construction, in further embodiments the first portion 322 may be substantially C-shaped, substantially planar, and/or any other configuration. Such shapes and/or other configurations may assist in, for example, forming one or more substantially fluid-tight seals between, for example, the first portion 322 and the inner wall 310 of the chamber 308. Additionally, such shapes and/or other configurations may assist in, for example, forming one or more gaps between the first portion 322 and various other components of the regulator 322.

Further, the materials utilized to manufacture the first and/or second portions 322, 324 of the barrier assembly 320 may also assist in enhancing the functionality of the regulator 222. For example, in some embodiments at least the first portion 322 may comprise a substantially flexible component of the regulator 222. In such embodiments, for example, the perimeter, sidewall, and/or other surfaces or sections of the first portion 322 may be connected to and/or fixed relative to the inner wall 310. In such embodiments, the first portion 322 may comprise a substantially flexible diaphragm. While, for example, the perimeter and/or other section of such an example first portion 322 may be fixed relative to the chamber 308, a second section of the first portion 322, such as a substantially central section, may be movable relative to the chamber 308 during operation of the regulator 222. For example, the flexible nature of such an example first portion 322 may enable the central section to move in response to changes in fluid pressures within the chamber 308 while the perimeter of the first portion 322 may remain in a fixed position relative to the chamber 308. Such a flexible first portion 322 will be described in greater detail below with respect to FIG. 4.

Alternatively, at least the first portion 322 may comprise a substantially rigid component of the regulator 222. In such embodiments, the first portion 322 may comprise, for example, a substantially rigid piston movably disposed within the chamber 308. In such embodiments, the first portion 322 may comprise any shape, size, thickness, dimensioned, and/or other configuration to assist in achieving a desired level of rigidity. Additionally, in such embodiments, substantially the entire first portion 322 may be movable relative to the chamber 308. In such embodiments, the first portion 322 may be substantially fluidly sealed to the chamber 308 while being movable relative thereto. For example, the regulator 322 may include one or more seals 326 configured to assist in forming a substantially fluid-tight seal between the inner wall 310 of the chamber 308 and the first portion 322. In such embodiments, the seal 326 may comprise an O-ring, a gasket, and/or any other like device configured to assist in forming a substantially fluid-tight seal between two adjacent moving components. For example, the seal 326 may assist in forming a substantially fluid-tight seal between the first portion 322 and the inner wall 310 while the first portion 322 moves relative to the inner wall 310, and while the first portion 322 and/or the seal 326 is subjected to any of the pressures described above.

The first portion 322 may include, for example, a first side 328 (i.e., a top surface) and a second side 330 (i.e., a bottom surface) opposite the first side 328. In such embodiments, the first portion 322 may also include one or more sidewalls extending from the first side 328 to the second side 330. In such embodiments, the seal 326 may be disposed proximate, adjacent, and/or otherwise in communication with the sidewalls of the first portion 322 to assist in forming a substantially fluid-tight seal between the first portion 322 and the inner wall 310. In some embodiments, the sidewall of the first portion 322 may include one or more notches, grooves, channels, cutouts, and/or other like structures to assist in mounting the seal 326 on the first portion 322. In such embodiments, the seal 326 may move with and/or otherwise be carried by the first portion 322 as the first portion 322 moves relative to the inner wall 310. Further, it is understood that portions of the seal 326 and/or the first portion 322 may be at least partially coated with oil and/or any other like lubricants to assist in forming such a substantially fluid-tight seal.

As shown in FIG. 3, the regulator 222 may also include a head 332. In some embodiments, at least a portion of the head 332 may be disposed at least partially within the chamber 308. In such embodiments, the head 332 may be connected to the housing 302 and/or to the chamber 308 in any known way. For example, the head 332 may be removably connected to the chamber 308. In such embodiments, the head 332 may comprise a plug or other like structure configured to be press-fit, threadingly coupled, and/or otherwise removably disposed within the chamber 308. Further, similar to the first portion 322, the head 332 may be substantially fluidly sealed to the chamber 308. For example, at least a portion of the head 332 may be substantially fluidly sealed to the inner wall 310, and the head 332 may include one or more seals 334 configured to assist in forming a substantially fluid-tight seal between the head 332 and the inner wall 310. In such embodiments, the seal 334 may be substantially structurally similar to the seal 326 described above with respect to the first portion 322. In addition, the head 332 may include one or more notches, grooves, channels, cutouts, and/or other like structures to assist in mounting the seal 334 on the head 332. In such embodiments, the seal 334 may be carried by the first portion head 332 as the head 332 is inserted within and/or removed from the chamber 308. Further, it is understood that portions of the seal 334 and/or the head 332 may be at least partially coated with oil and/or any other like lubricants to assist in forming a substantially fluid-tight seal between the inner wall 310 and the head 332.

When the head 332 is disposed at least partially within the chamber 308, the head 332 may define and/or otherwise form at least part of a first gap 336 extending from the head 332 to the first side 328 of the first portion 322. In such embodiments, fluid within the first gap 336 may have a first fluid pressure. Such a first fluid pressure may be a positive pressure formed within the first gap 336 by inserting the head 332 at least partially within the chamber 308. For example, the seal 334 may form a substantially fluid-tight seal between the inner wall 310 and the head 332 as the head 332 is inserted into the chamber 308, and this seal may capture air and/or other like fluids within the first gap 336. Additionally, due to the substantially fluid-tight seal formed by the seal 326 between the inner wall 310 and the first portion 322, such fluids may not be able to escape from the first gap 336 upon insertion of the head 332. Moving the head 332 in, for example, a first direction 338 within the chamber 308 during insertion may compress the fluids contained within the first gap 336 such that the first gap 336 may be maintained at a desired first fluid pressure while the head 332 is disposed within the chamber 308. The first fluid pressure within the first gap 336 may bias the barrier assembly 320 in the first direction 338 away from the head 332. In particular, the positive first fluid pressure within the first gap 336 may act on substantially the entire first side 328 of the first portion 322, thereby biasing at least the first portion 322 in the first direction 338.

In some embodiments, the positive first fluid pressure within the first gap 336 may be variable. For example, the first fluid pressure may be increased by moving the head 332 in the first direction 338 toward the first portion 322. Alternatively, the first fluid pressure within the first gap 336 may be decreased by moving the head 332 away from the first portion 322. Such movement of the head 332 may be accomplished in any number of ways. For example, the head 332 may include one or more grips, notches, and/or other like surfaces or components that may be directly manually manipulated in order to adjust the position of the head 332 within the chamber 308 relative to the first portion 322.

Alternatively, and/or in addition, a cap 340 may be connected to the head 332 and configured to facilitate movement of the head 332 relative to the first portion 322. For example, the cap 340 may include a set of threads configured to mate with the threads 318a formed on the outer wall 316 of the housing 302. In such embodiments, rotating the cap 340 in a clockwise direction about the longitudinal axis 314 may tighten the cap 340 onto the housing 302 and may cause commensurate movement of the head 332 in the first direction 338. Such movement of the head 332 may, for example, increase the first fluid pressure within the first gap 336. Conversely, rotating the cap 340 in a counterclockwise direction about the longitudinal axis 314 may loosen the cap 340 and may cause commensurate movement of the head 332 away from the first portion 322, such as in a second direction 342 opposite the first direction 338. Such movement of the head 332 may, for example, decrease the first fluid pressure within the first gap 336. The cap 340 may be rotatable relative to the head 332 or, alternatively, the cap 340 may be fixed to the head 332 such that rotation of the cap 340 causes commensurate rotation of the head 332. In some embodiments, the cap 340 and/or the outer wall 316 of the housing 302 may include one or more visible indicia indicative of various desired pressures corresponding to the first fluid pressure within the first gap 336. Such visible indicia may assist in tuning the regulator 222 such that a desired first fluid pressure may be obtained within the first gap 336. In still further example embodiments, the housing 302 may include one or more ports (not shown) fluidly connected to the chamber 308 and/or the first gap 336. In such embodiments, a flow of pressurized fluid may be directed to the first gap 336 via the one or more ports to assist in obtaining a desired first fluid pressure within the first gap 336 and/or maintaining the first gap 336 at a desired first fluid pressure. It is understood that one or more check valves and/or other like components may be fluidly connected to such ports to assist in directing pressurized fluid to the first gap 336 in a controlled manner.

As shown in FIG. 3, the second side 330 of the first portion 322 may define and/or otherwise form at least part of a second gap 344 within the chamber 308. For example, such a second gap 344 may extend from the second side 330 to the base 312 of the chamber 308. In such embodiments, the second gap 344 may include fluid having a second fluid pressure, and at least the first portion 322 of the barrier assembly 320 may be movable in response to a change in the second fluid pressure of the second gap 344. In an example embodiment, the fluid in at least one of the first and second gaps 336, 344 may comprise a compressible fluid. In such an embodiment, the fluid in at least one of the first and second gaps 336, 344 may comprise any of the fluids described above with respect to the pressure vessels 208.

The outlet 306 of the housing 302 may be directly fluidly connected to the chamber 308 and/or to the second 344. The inlet 304 of the housing 302, on the other hand, may be selectively fluidly connectable to the chamber 308 and/or to the second gap 344. For example, the second portion 324 of the barrier assembly 320 may be configured to selectively fluidly connect the inlet 304 to the chamber 308. In particular, the second portion 324 of the barrier assembly 320 may comprise a substantially rigid stem or other like member extending substantially perpendicularly from the second side 330 of the first portion 322. In such embodiments, the second portion 324 may include one or more structures, features, and/or other like components configured to assist in forming a substantially fluid-tight seal with the housing 302 when the first fluid pressure within the first gap 336 is substantially equal to the second fluid pressure within the second gap 344. Additionally, the second portion 324 may include one or more structures, features, and/or other like components configured to direct fluid from the inlet 304 to the chamber 308, such as to the second gap 344, when the first fluid pressure within the first gap 336 is different than the second fluid pressure within the second gap 344.

For example, the second portion 324 may include a substantially annular shoulder 346 configured to assist in forming such a substantially fluid-tight seal with the housing 302. The shoulder 346 may comprise, for example, one or more flanges, extensions, and/or other like structures or portions extending in a direction substantially perpendicular to, for example, the longitudinal axis 314. Alternatively, in further embodiments, the shoulder 346 may extend at any other angle between approximately 0 degrees and approximately 180 degrees relative to the longitudinal axis 314 to assist in forming a substantially fluid-tight seal with the housing 302. In further embodiments, the shoulder 346 may comprise a tapered portion of the second portion 324 such that at least a portion of the second portion 324 be substantially wedge-shaped. In such embodiments, the taper may be linear, arcuate, curved, and/or may have any other configuration useful in forming the substantially fluid-tight seal described herein.

In any of the embodiments described herein, the regulator 322 may include one or more additional seals 348 configured to form a substantially fluid-tight seal between the shoulder 346 and the housing 302. In an example embodiment, the one or more seals 348 may be substantially structurally similar to one or more of the seals 326, 334 described above. Accordingly, when the barrier assembly 320, and thus the second portion 324, is moved in the second direction 342, the shoulder 346 may mate with the seal 348 to form a substantially fluid-tight seal between the second portion 324 and the housing 302. When such a seal is formed, compressed fluid from, for example, a pressure vessel 208 removably connected to the housing 302 at the inlet 304 may be blocked from entering the chamber 308 and/or the second gap 344. It is understood that such a substantially fluid-tight seal between the second portion 324 and the housing 302, and in particular, between the shoulder 346 and the seal 348, may be formed when the first fluid pressure within the first gap 336 is substantially equal to the second fluid pressure within the second gap 344. On the other hand, when the barrier assembly 320 and/or the second portion 324 is moved in the first direction 338, the substantially fluid-tight seal between the shoulder 346 and the seal 348 may be broken such that compressed fluid from the pressure vessel 208 may be permitted to enter the chamber 308 via at least part of the second portion 324. In example embodiments, the shoulder 346 and/or the seal 348 may permit passage of fluid into the second gap 344 in response to the second fluid pressure within the second gap 344 being less than the first fluid pressure described above.

In example embodiments, the second portion 324 may include one or more channels 350 or other like portions configured to fluidly connect the inlet 304 to the chamber 308 when the substantially fluid-tight seal between the shoulder 346 and the seal 348 is broken. Such a channel 350 may include, for example, a substantially longitudinal groove, notch, and/or other like structure (i.e., portion) defining a fluid passageway between the inlet 304 and the chamber 308. In example embodiments, the channel 350 may extend substantially parallel to, for example, the longitudinal axis 314 and such a channel 350 may be configured to direct passage of fluid into the second gap 344 in response to the second fluid pressure being less than the first fluid pressure. It is also understood that the housing 302 may further include one or more seals 352 forming a substantially fluid-tight seal with the pressure vessel 208 when the pressure vessel 208 is supported by the holder 108 and is fluidly connected to the inlet 304. Such seals 352 may be substantially structurally similar to any of the seals 326, 334, 348 described above.

Further, in example embodiments the pressure vessel 208 may be removably connectable to the housing 302 at the inlet 304, and compressed fluid supplied by the pressure vessel 208 may assist in applying a third fluid pressure to the second portion 324. In such embodiments, the third fluid pressure may bias the second portion 324 in the second direction 342, and such a fluid pressure may assist in forming a substantially fluid-tight seal between the shoulder 346 and the seal 348. In some embodiments, the third fluid pressure provided by the compressed fluid within the pressure vessel 208 may be greater than or substantially equal to at least one of the first and second fluid pressures described above. As will be described in greater detail below, such a third fluid pressure may provide a counterbalancing effect during operation. In particular, the second portion 324 may be configured to move in the first direction 338 in response to compressed fluid passing, via the outlet 306, from the second gap 344. Such compressed fluid may pass from the second gap 344 through, for example, the valve 230 (FIG. 2), via the outlet 306. In such embodiments, the second portion 324 may be configured to move in the second direction 342 in response to compressed fluid passing, via the second portion 324, from the pressure vessel 208. For example, such compressed fluid may pass from the pressure vessel 208 into the second gap 344, via the channel 350, while the substantially fluid-tight seal between the seal 348 and the shoulder 346 is temporarily broken.

FIG. 4 illustrates an example regulator 400 in accordance with another embodiment of the present disclosure. The regulator 400 may include substantially identical components to those described above with respect to the regulator 222 shown in FIG. 3, except that the regulator 400 may include a barrier assembly having a substantially flexible first portion. For instance, the regulator 400 of FIG. 4 may include a housing 402 having an inlet 404, an outlet 406, and a chamber 308 having an inner wall 410 and a base 412. These components of the regulator 400 may be substantially structurally similar to the corresponding components of the housing 302 described above with respect to the regulator 222. Additionally, the chamber 308 may include a central longitudinal axis 414, and a barrier assembly 416 may be at least partially disposed within the chamber 308. The barrier assembly 416 may include a first portion 418, and a second portion 420 connected to the first portion.

In the embodiment of FIG. 4, the first portion 418 may comprise a substantially flexible diaphragm having a sidewall 422 that is fixedly mounted to and/or otherwise substantially fluidly sealed to the inner wall 410. Such a substantially flexible first portion 418 may be made from any of the materials described above with respect to the first portion 322 of the barrier assembly 320, and the first portion 418 may have a thickness, shape, and/or other configuration that enables at least one section of the first portion 418 to deflect and/or otherwise move while the sidewall 422 remains stationary relative to the inner wall 410. For example, the first portion 418 may be made from a relatively flexible plastic, polymer, and/or other like material, and may have a thickness that is less than a corresponding thickness of the first portion 322. Such a configuration may facilitate movement of, for example, a central section of the first portion 422. The central section of the first portion 422 may be disposed anywhere between the sidewall 422 and, for example, the central longitudinal axis 414 may pass through at least part of the central section. Additionally, such movement may be along the axis 414. In such embodiments, the central section may move one or more centimeters along the longitudinal axis 414, however, in further embodiments, such movement may be less than one centimeter. Such movement may be caused by and/or in response to a fluid pressure on a first side 424 of the first portion 418 being different (i.e., greater than or less than) a fluid pressure on a second side 426 of the first portion 418. Such movement may cause commensurate movement of the second portion 420 connected to the first portion 418.

As shown in FIG. 4, the regulator 400 may further include a head 428 removably connected to the housing 402. For example, similar to the head 332 described above, the head 428 may be substantially fluidly sealed to the inner wall 410, and the regulator 400 may include one or more seals 430 to assist in forming such a seal. Additionally, the head 428 may define and/or otherwise form at least part of a first gap 432 extending from the head 428 to the first side 424 of the first portion 418. A second gap 434 may also be defined and/or otherwise formed by at least part of the base 412 and at least part of the second side 426. In such embodiments, the first gap 432 may include fluid at a first fluid pressure and the second gap 434 may include fluid at a second fluid pressure.

The regulator 400 may function in substantially the same manner as the regulator 222 except that the sidewall 422 of the first portion 418 may remain stationary relative to the inner wall 410 during use. For instance, at equilibrium and/or while substantially no gas exits the regulator 400 through the outlet 406, the first fluid pressure within the first gap 432 may be substantially equal to the second fluid pressure within the second gap 434. In this condition, for example, the central section of the first portion 418, as well as the second portion 420, may be maintained at a fixed position within the chamber 408. On the other hand, when gas exits the regulator 400 through the outlet 406, the second fluid pressure within the second gap 434 may be reduced to a pressure less than the first fluid pressure. In this condition, a biasing force provided by the first fluid pressure in the first gap 432 may cause the central section of the first portion 418 to flex. Such flexing may be, for example, in the first direction 338. Such flexing may cause commensurate movement of the second portion 420 in the first direction 338, and may break a substantially fluid-tight seal formed between the second portion 420 and the housing 402. While such a seal is broken, compressed fluid may enter the second gap 434.

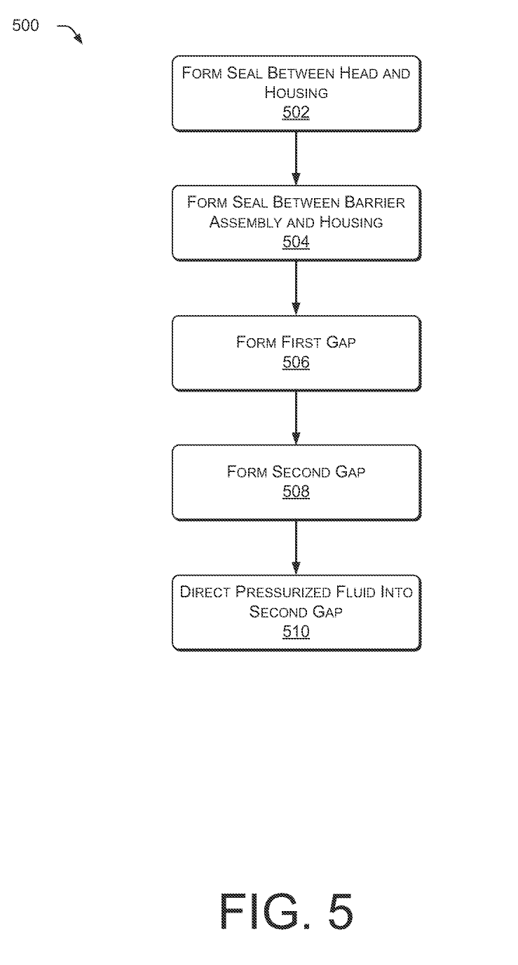

FIG. 5 shows a flowchart 500 illustrating an example method of the present disclosure. The steps shown in the flowchart 500 may be applicable to any of the regulator embodiments described herein. However, for ease of description, the method illustrated by the flowchart 500 will be described below with respect to the regulator 222 shown in FIG. 2. Further, it is understood that the various steps illustrated in the flowchart 500 may be performed in any order, and the order shown in FIG. 5 should not be interpreted as limiting the scope of the present disclosure in any way.

As illustrated in FIG. 5, during operation of the dispenser 100 and/or of the regulator 222 a substantially fluid-tight seal may be formed between the housing 402 and the head 332 at 502. For example, such a substantially fluid-tight seal may be formed between the head 332 and the inner wall 310 by one or more seals 334 disposed therebetween. Further, such a seal may be formed by inserting at least a portion of the head 332 within the chamber 308 such that the seal 334 mates with the inner wall 310.

At 504, a substantially fluid-tight seal may be formed between the barrier assembly 320 and the housing 302, such as between the first portion 322 and the chamber 308. In particular, such a substantially fluid-tight seal may be formed between the seal 326 in communication with a sidewall of the first portion 322 and the inner wall 310 of the chamber 308.

Inserting the head 332 into the chamber 310 may include forming, at 506, a first gap 336 between the head 332 and the first side 328 of the first portion 322. Inserting the head 332 into the chamber 310 may also include moving the head 332, substantially along the longitudinal axis 314 in the first direction 338. Moving the head 332 in the first direction 338 may increase the pressure within the first gap 336. For example, the head 332 may be positioned within the chamber 308 relative to the first portion 322 such that a desired first fluid pressure may be achieved within the first gap 336. Such a first fluid pressure may bias the barrier assembly 320 in the first direction 338 away from the head 332.

At 508, a second gap 344 may be formed between the second side 330 of the first portion 322 and the base 312 of the chamber 308. The second gap 344 may be maintained at and/or otherwise characterized by a second fluid pressure. At equilibrium and/or while substantially no gas exits the regulator 222 through the outlet 306, the first fluid pressure within the first gap 336 may be substantially equal to the second fluid pressure within the second gap 344. In this condition, the first portion 322 may be maintained at a fixed position within the chamber 308 relative to the head 332.

On the other hand, when gas is permitted to exit the regulator 222 through the outlet 306, such as by intermittently opening the valve 330, the second fluid pressure within the second gap 344 may be reduced to a pressure less than the first fluid pressure. In this condition, the biasing force provided by the first fluid pressure in the first 336 may cause the barrier assembly 320 move in the first direction 338. Such movement may break the substantially fluid-tight seal formed between the shoulder 346 and the seal 348. While such a seal is broken, compressed fluid from the pressure vessel 208 may be directed into the second gap 334 via the channel 350 at 510. The compressed fluid entering the second gap 344 may increase the second fluid pressure within the second gap 344 until the second fluid pressure is again substantially equal to the first fluid pressure within the first 336. Once the second fluid pressure within the second gap 344 is again substantially equal to the first fluid pressure within the first gap 336, the shoulder 346 may form a substantially fluid-tight seal with the seal 348, thereby prohibiting additional pressurized fluid from entering the second gap 344.

In this way, the regulator 222 may be operated without the use of a conventional mechanical spring. As a result, the regulator 222 may be less expensive than conventional regulators due to a reduction in component cost. Additionally, since the regulator 222 may employ fewer components than conventional regulators, the regulator 222 may be less complicated than conventional regulators and may be less prone to failure.

### Other Example Embodiments

While the foregoing examples describe using example springless regulators in dispensers to dispense products, such as cosmetic products, paint, or the like, in other examples, springless regulators according to this disclosure may be used for other purposes. For example, springless regulators may be used to regulate pressures in paint ball guns, air soft guns, pellet guns, BB guns, etc. In other examples, springless regulators may be used to regulate pressures in other applications including, but not limited to, paint application, medicinal use, pesticide spraying, crop fertilization, etc.

### CONCLUSION

Although various embodiments have been described in language specific to structural features and/or methodological acts, it is to be understood that the claims are not necessarily limited to the specific features or acts described. Rather, the specific features and acts are disclosed as illustrative forms of implementing the embodiments.

What is claimed is:

1. A regulator, comprising:
a housing including an inlet, an outlet, and a chamber, wherein the inlet is selectively fluidly connectable to the chamber;
a barrier assembly disposed within the housing, the barrier assembly including a first portion moveable relative to the chamber, and a second portion configured to selectively fluidly connect the inlet to the chamber;
a head removably connected to the chamber, a first gap extending from the head to a first side of the first portion of the barrier assembly, wherein
the first gap containing a fluid having a first fluid pressure biasing the barrier assembly in a first direction away from the head,
the first portion includes a second side opposite the first side, a second gap extending from the second side to a base of the chamber, and
the second gap containing a fluid having a second fluid pressure, the first portion being moveable in response to a change in the second fluid pressure.

2. The regulator according to claim 1, wherein the first portion is connected to the second portion, and at least one of the first portion and the second portion is fluidly sealed to the chamber.

3. The regulator according to claim 1, wherein the first portion comprises a substantially flexible diaphragm having a first section fixed relative to the chamber and a second section moveable relative to the chamber.

4. The regulator according to claim 1, wherein the first portion comprises a substantially rigid piston moveably disposed within the chamber, the piston being substantially fluidly sealed to the chamber.

5. The regulator according to claim 1, wherein the second portion comprises a substantially rigid stem extending substantially perpendicularly from the second side of the first portion, wherein a decrease in the second fluid pressure within the second gap fluidly connects the inlet to the chamber via at least part of the stem.

6. The regulator according to claim 5, wherein the stem further includes a portion configured to fluidly connect the inlet to the chamber, and a shoulder selectively fluidly sealed to the housing.

7. The regulator according to claim 5, further comprising a pressure vessel fluidly connectable to the inlet, wherein a compressed fluid within the pressure vessel applies a third fluid pressure to the stem.

8. The regulator according to claim 7, wherein the third fluid pressure is greater than at least one of the first and second fluid pressures, and wherein the third fluid pressure biases the stem in a second direction toward the head.

9. The regulator according to claim 7, wherein the compressed fluid comprises at least one of carbon dioxide or nitrous oxide.

10. The regulator according to claim 1, wherein the chamber comprises a substantially cylindrical inner wall and a central longitudinal axis, the first portion being moveable substantially along the longitudinal axis in response to the change in the second fluid pressure.

11. The regulator according to claim 10, further comprising a first seal forming a substantially fluid-tight seal between the head and the inner wall, and a second seal forming a substantially fluid-tight seal between the first portion and the inner wall.

12. The regulator according to claim 11, further comprising a third seal, the third seal forming a substantially fluid-tight seal between the second portion and the housing when the first fluid pressure is substantially equal to the second fluid pressure, and the third seal permitting passage of fluid into the second gap in response to the second fluid pressure being less than the first fluid pressure.

13. The regulator according to claim 1, further including a cap connected to the head and removably connectable to the housing, wherein movement of the cap relative to the housing, while the cap is connected to the housing, results in a corresponding change in the first fluid pressure.

14. A system, comprising:
a regulator, the regulator including:
a housing having an inlet, an outlet, and an internal chamber,
a barrier assembly disposed within the housing and moveable along a central longitudinal axis of the chamber, the barrier assembly including a piston having a first side and a second side opposite the first side, and a stem extending from the second side of the piston, the piston being substantially fluidly sealed to an inner wall of the chamber, and
a head substantially fluidly sealed to the inner wall of the chamber, the head forming at least part of a first gap extending from the head to the first side of the piston, wherein
the first gap includes a fluid having a first fluid pressure biasing the barrier assembly in a first direction away from the head,
the second side forms at least part of a second gap extending from the second side to a base of the chamber, and
the second gap includes a fluid having a second fluid pressure, the barrier assembly being moveable in the first direction in response to the second fluid pressure decreasing to a pressure less than the first fluid pressure;
an actuatable valve fluidly connected to the outlet, the valve being configured to decrease the second fluid pressure to the pressure less than the first fluid pressure; and
a holder configured to house a pressure vessel while the pressure vessel is fluidly connected to the inlet.

15. The system of claim 14, further comprising a first seal forming a substantially fluid-tight seal between the head and the inner wall, and a second seal forming a substantially fluid-tight seal between the piston and the inner wall.

16. The system of claim 14, further comprising a seal forming a substantially fluid-tight seal between the stem and the housing when the first fluid pressure is substantially equal to the second fluid pressure, the seal permitting passage of fluid into the second gap in response to the second fluid pressure being less than the first fluid pressure.

17. The system of claim 16, wherein the stem comprises a shoulder configured to mate with the seal, and a longitudinal channel configured to direct passage of fluid into the second gap in response to the second fluid pressure being less than the first fluid pressure.

18. The system of claim 14, further comprising a seal forming a substantially fluid-tight seal with the pressure vessel when the pressure vessel is supported by the holder and fluidly connected to the inlet.

19. The system of claim 14, further comprising a cap connected to the head and removably connectable to the housing, wherein movement of the cap relative to the housing, while the cap is connected to the housing, results in a corresponding change in the first fluid pressure.

20. The system of claim 14, wherein the piston is configured to move in the first direction in response to compressed fluid passing, via the outlet, from the second gap through the valve.

21. The system of claim 20, wherein the piston is configured to move in a second direction opposite the first direction in response to compressed fluid passing, via the stem, from the pressure vessel into the second gap.

22. A method of regulating fluid flow, comprising:
forming a substantially fluid-tight seal between a head and a housing of a regulator, the housing including a chamber having a base and an inner wall;
forming a substantially fluid-tight seal between the inner wall and a barrier assembly disposed within the chamber, the barrier assembly including a first portion and a second portion;
forming a first gap within the chamber, the first gap extending from the head to a first side of the first portion of the barrier assembly; and
forming a second gap within the chamber, the second gap extending from a second side of the first portion to the base, wherein
the first gap includes a fluid having a first fluid pressure biasing the barrier assembly in a first direction away from the head;
the second gap includes a fluid having a second fluid pressure, and
the first portion is moveable in response to a change in the second fluid pressure.

23. The method of claim 22, further including directing pressurized fluid into the second gap in response to movement of the first portion.

24. The method of claim 23, further including directing the pressurized fluid into the second gap via the second portion of the barrier assembly, the second portion of the barrier assembly being selectively fluidly sealed to the housing.

25. The method of claim 22, wherein the chamber comprises a central longitudinal axis, and wherein movement of the first portion comprises movement substantially along the longitudinal axis in response to the change in the second fluid pressure.

26. The method of claim 22, further comprising forming a substantially fluid-tight seal between the second portion and the housing when the first fluid pressure is substantially equal to the second fluid pressure, and directing fluid into the second gap, via the second portion, in response to the second fluid pressure being less than the first fluid pressure.
